(19) United States
(12) Patent Application Publication
(10) Pub. No.: US 2010/0213778 A1
(43) Pub. Date: Aug. 26, 2010

(54) Magnetic Motor With Associated Alternator

(76) Inventor: Roger C. Knutson, Indianapolis, IN (US)

Correspondence Address: Bruce J. Bowman;Bowman & Associates, 1016 3rd Ave. SW, Suite 106, Carmel, IN, 46032, US

(21) Appl. No.: 12/711,505

(22) Filed: Feb. 24, 2010

Related U.S. Application Data
(60) Provisional application No. 61/208,293, filed on Feb. 24, 2009.

(51) Int. Cl. H02K 21/30; H02K 21/26; H02K 5/18; H02K 9/19; H02K 53/00

(52) U.S. Cl. 310/154.02; 310/154.21; 310/64; 310/54; 415/916

(57) ABSTRACT

An electromechanical device or magnetic motor includes a plurality of rotor magnet assemblies, a plurality of drive magnet assemblies that are laterally moveable with respect to the rotor magnet assemblies, a timing assembly for generating power pulses selectively supplied to the drive magnet assemblies, and electromagnetic coils associated with the drive magnet assemblies to receive the power pulses from the timing assembly to momentarily disrupt the magnetic field of such assemblies at selected times. The magnetic assemblies of the rotor mechanically rotate a shaft and interact with alternator windings to generate electrical power. The magnetic motor is self-contained with start/stop, rotational speed, diagnostics, global positioning, CPU and interface capability.

### RELATED APPLICATIONS

This patent application claims the benefit of and/or priority to U.S. Provisional Patent Application Ser. No. 61/208,293 filed Feb. 24, 2009, entitled “Magnetic Motor With Associated Alternator—Magnator” the entire contents of which is specifically incorporated herein by this reference.

### BACKGROUND OF THE INVENTION

1. Field of the Invention

The present invention relates to rotating machinery to serve as an input to other torque driven equipment such as generators, transmission sets, pumps and the like and, more particularly, to a magnetic rotating machine to serve as an input to other torque driven equipment such as generators, transmission sets, pumps and the like

2. Background Information

Motors composed of a rotating shaft and powered through the use of electromotive force applied to a precise geometrical configuration of permanent magnets and/or electro-magnets are well known in the art. Many examples of such motors are disclosed in U.S. patents and U.S. patent publications some of which are discussed below while others are provided as cited references.

An example of a magnetic motor assembly is provided in U.S. Pat. No. 5,627,419 issued to Miller on May 6, 1997. The Miller magnetic motor consists of a flywheel system having permanent magnets disposed on a flywheel rotating about a shaft and a stator. The stator is adjustable with respect to the shaft and the flywheel in order to produce an electromagnetic field that facilitates electromagnetic engagement of the stator and the rotor/flywheel assembly for providing angular velocity.

Additionally, U.S. Pat. No. 6,005,317 issued to Lamb on Dec. 21, 1999, discloses an adjustable magnet coupler that has a group of magnet rotors with permanent magnets separated by air gaps from another set of nonferrous conductor elements connected to a group of conductor rotors. The air gaps are adjusted by axial movement of one of the groups relative to the other. This movement alters the slip of the coupler and control of the speed under varying load conditions. Lamb also provides instruction for the use of permanent magnets in connection with conducting rotors.

Another magnetic motor is disclosed in U.S. Pat. Nos. 6,806,610 and 7,402,929 issued to Dilliner on Oct. 19, 2004 and Jul. 22, 2008, respectively, that provides for a motor with a plurality of rotor magnets positioned along a rotor that is mounted on a shaft. A plurality of drive magnets are movably positioned uniformly adjacent to the rotor magnets to cause rotation of the rotor. The perpendicular motion of the drive magnets into and out of juxtaposed positions with the rotor magnets can control the relative velocity of the shaft and drive magnets. The non-rotating disk and magnet assemblies are electrically pulsed through a timing assembly that provides power pulses that are selectively supplied to each magnet. Brush slip rings are utilized for transferring electrical power from an alternator to the rotor magnet.

A problem with the above-described and all other prior art magnetic motors is their low power output, low efficiency and high complexity. Another problem is their inability to provide a wide range of power output from low power to high power. Other problems with these magnetic motors also exist.

As such, it is an object of the present invention to provide an improvement over the prior art by providing a magnetic motor that is adapted to produce both low to high and/or high power, is efficient and relatively simple whereby the magnetic motor can be utilized for a wide variety of low power to high power applications.

It is further an object of the present invention to provide additional improvements over the prior art by incorporating and including therein proper recognition of magnetic flux characteristics to prevent lock-up of the electromagnetic field, provide heat dissipation, provide internal electrical generation, provide computer controlled operation and other features as described herein.

### SUMMARY OF THE INVENTION

The present invention is an electromechanical device designed to rotate a shaft-rotor assembly to produce the maximum intrinsic force and torque in order to enable other machinery such as generators or transmissions to operate successfully in conjunction with the present electromechanical device. The present electromechanical device incorporates an internal alternator winding that generates electrical current which is utilized within the present electromechanical device and also distributed externally.

The electromechanical device, in one form, defines a magnetic motor that includes a plurality of rotor magnet assemblies, a plurality of drive magnet assemblies that are laterally moveable with respect to the rotor magnet assemblies, a timing assembly for generating power pulses selectively supplied to the drive magnet assemblies, and electromagnetic coils associated with the drive magnet assemblies to receive the power pulses from the timing assembly to momentarily disrupt the magnetic field of such assemblies at selected times. The magnetic assemblies of the rotor mechanically rotate a shaft and interact with alternator windings to generate electrical power.

The rotating shaft is locked into position through the center of the device via high performance bearings such as, but not limited to, magnetic bearings capable of high temperature and high rotational speeds. The shaft's rotational power is generated inside a closed housing that is hermetically sealed to provide containment for special gases that will be described later.

The rotor/shaft is rotated by a combination of electromagnetic interactions that are timed via digital switching to elicit variable rotation of the shaft. Conventional motor nomenclature is used to describe the components intrinsic to this design. The use of a stator and rotor are utilized to turn the motor shaft. Either one of these components remains stationary while the other is attached to the shaft and made to rotate under controlled operations. The geometry of the rotating component is such that maximum torque can be achieved within the confines of the given containment unit. In a preferred embodiment rare earth permanent magnets of very high strength are used to propel the moving disk via interaction with other electro-magnets and/or permanent magnets. In other words the stator or the rotor or both may have a combination of electro-magnets and permanent magnets configured as to provide force to propel the rotating disk and shaft assembly to a controlled variable angular velocity.

The magnetic components are designed very specifically to provide maximum repulsive and /or attractive force in a direction that is perpendicular to the tangential line of force of the rotating disk component. The magnets themselves are designed geometrically to produce the maximum flux vector at a particular junction to the diametrically opposing magnet thereby providing maximum repulsive or attractive power to accelerate or decelerate the shaft speed. There are many variations of geometry that can be used to accomplish this maximum magnetic field density and all of those become an embodiment of the present invention. For example, permanent magnets that are configured in a conical design adjacent to a stationary rotor can exhibit maximum tangential force when the dipole face is geometrically designed to perfectly oppose an electro-magnet that is positioned in the rotor housing. The total number of permanent and/or electro-magnets is variable and dependent on the geometry of the magnets and the rotor/stator real estate available to position them as specified.

The present electromechanical device is adapted to provide a high power, efficient, relatively simplified magnetic motor that can be utilized for a wide variety of low power or high power applications. The present electromechanical device includes proper recognition of magnetic flux characteristics to prevent lock-up of the electromagnetic field, provide heat dissipation, provide internal electrical generation, provide computer controlled operation, and other features as described herein.

The present invention is yet another step in the evolutionary path of more energy efficient and environmentally conscientious designs.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a front perspective view of a preferred embodiment of the present magnetic motor according to the principles of the present invention;

FIG. 2 is a rear perspective view of the housing of the present magnetic motor of FIG. 1;

FIG. 3 is a cross-sectional view of the present magnetic motor taken along a centerline of FIG. 1;

FIG. 4a is a cross-sectional and perspective view of a drive magnet assembly included in the magnetic motor of FIG. 1;

FIG. 4b is a cross-sectional and perspective view of a drive magnet assembly included in the magnetic motor of FIG. 1; showing the magnetic flux lines;

FIG. 4c is a cross-sectional and perspective view of a drive magnet assembly included in the magnetic motor of FIG. 1; showing the magnetic flux lines with the influence of an attenuating cover;

FIG. 4d is a cross-sectional and perspective view of a drive magnet assembly included in the magnetic motor of FIG. 1; showing the electromagnetic attenuation cover;

FIG. 5 is a front view of a rotor assembly formed of a rotor and a plurality of rotor magnet assemblies included in the magnetic motor of FIG. 1;

FIG. 6 is a front view of a stator assembly formed of a hub and a plurality of stator magnet assemblies included in the magnetic motor of FIG. 1;

FIG. 7 is a front view of the rotor and stator including the timing and control assembly in the magnetic motor of FIG. 1; and

FIG. 8 is a block diagram of a timing circuit, sensors, CPU, GPS, alternator and control module that forms the electrical and interface assembly included in the magnetic motor of FIG. 1.

Like reference numerals indicate the same or similar parts throughout the several figures.

A complete discussion of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF EMBODIMENTS OF THE INVENTION

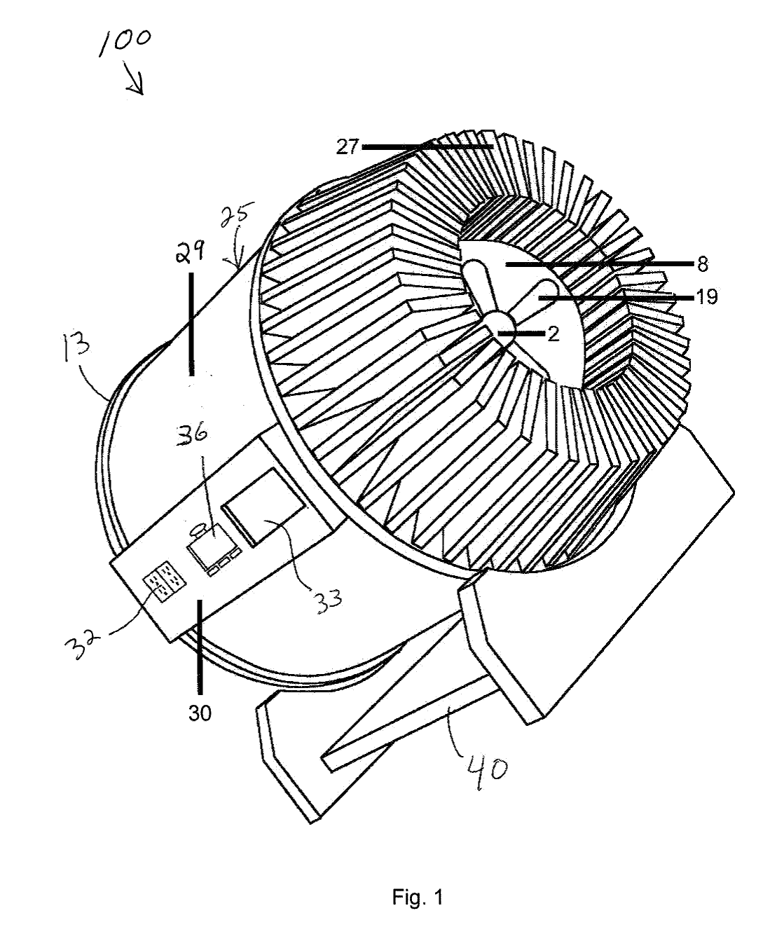

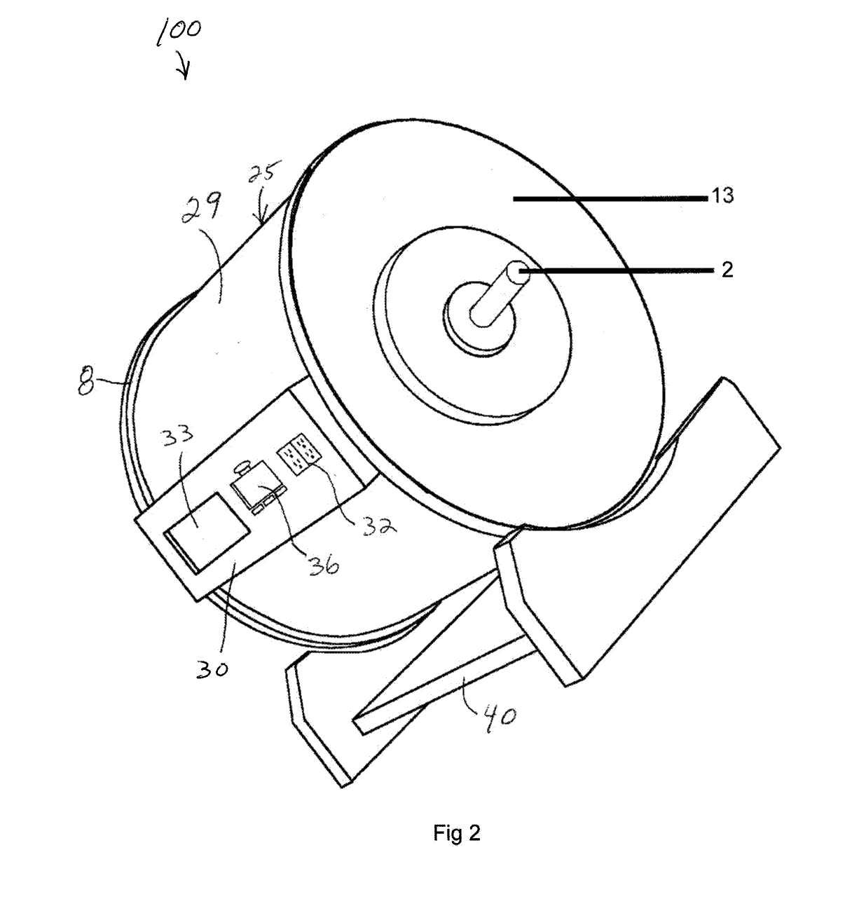

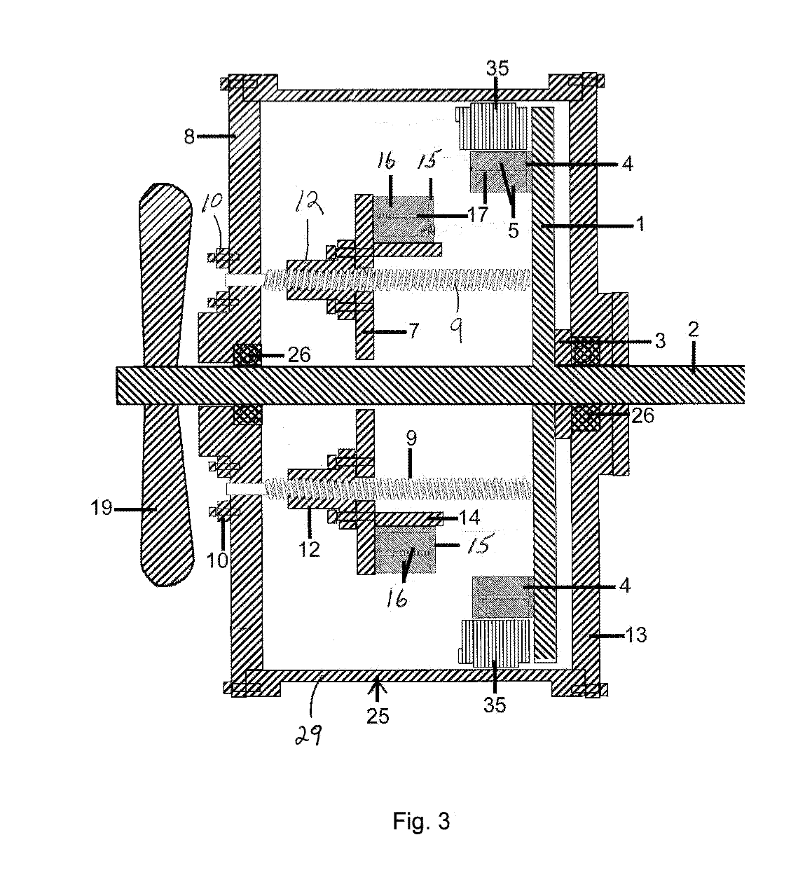

Referring to the figures, there is depicted an exemplary embodiment of an electromechanical device fashioned as a magnetic motor 100 and shown resting on a base or mount 40. It should be appreciated that the mount 40 is only exemplary of a manner of holding or retaining the magnetic motor 100. Other manners of mounting, retaining, holding or otherwise supporting the magnetic motor 100 may be used and are envisioned. The magnetic motor 100, as seen in FIGS. 1 and 2, has a housing 25 defined by a cylindrical cover 29 with a front plate 8 on one end thereof and a rear plate 13 on another end thereof. As best seen in FIG. 3, the housing 25 defines an interior, chamber, space within the cylindrical cover 29, front plate 8 and rear plate 13. While described further below, a control module 30 is mounted to the outside of the housing 25. The control module 30 includes electrical outlets 32, a display 33 and an embedded CPU, processor, circuitry and/or program instructions, along with USB ports and a timing assembly 36.

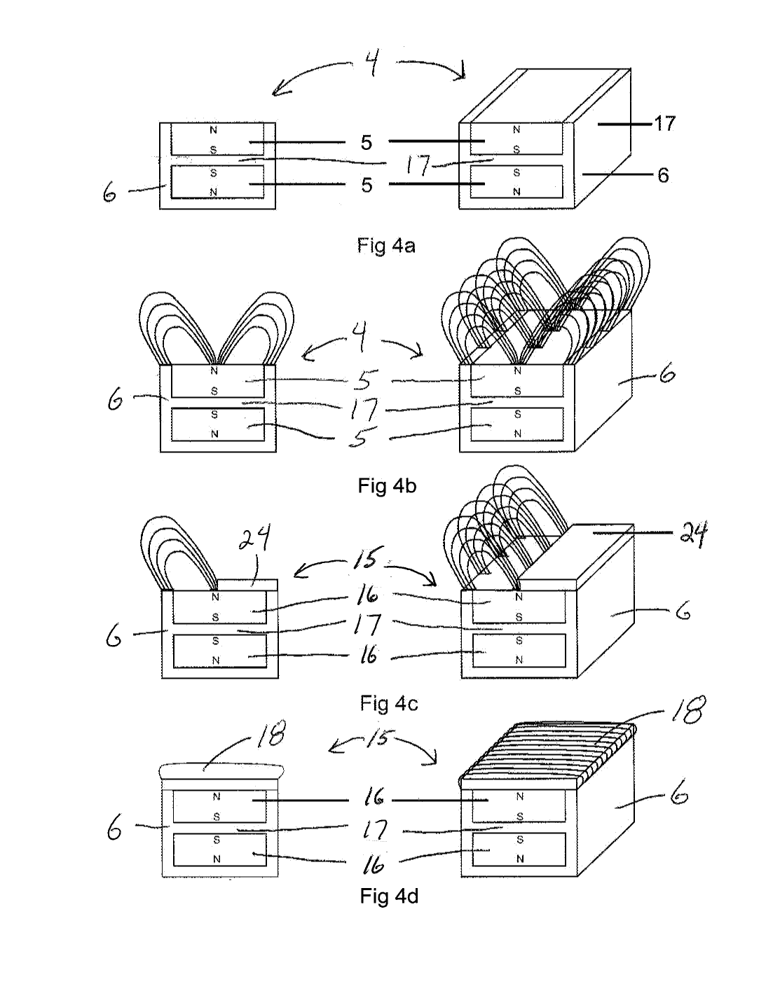

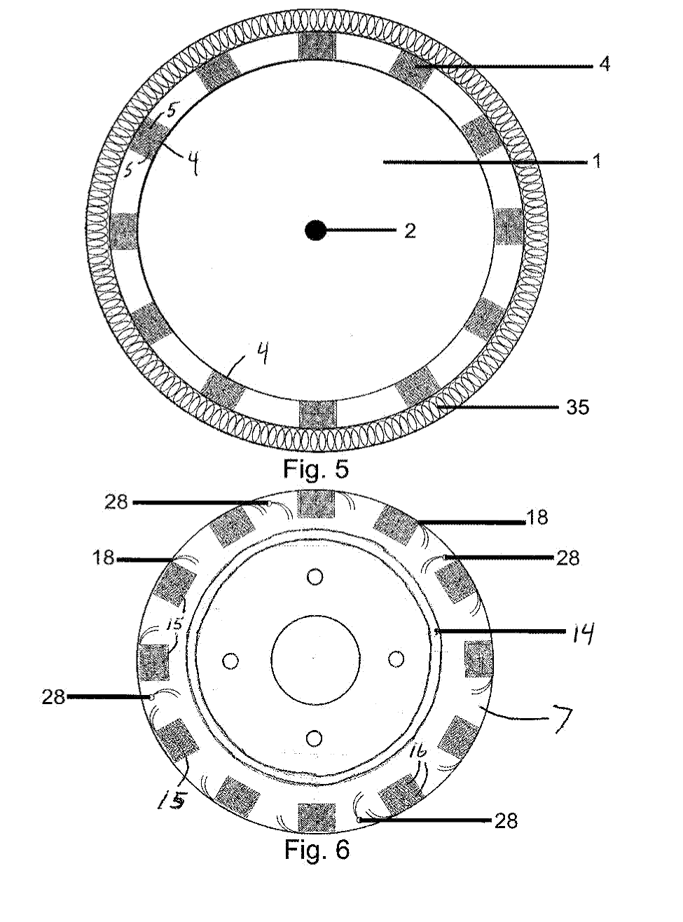

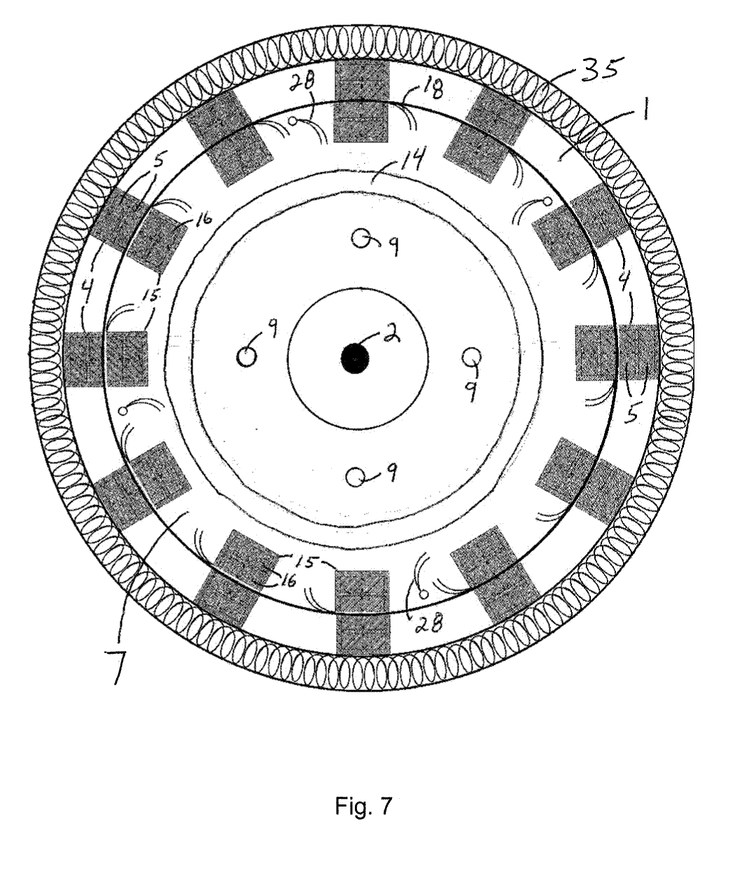

A rotor assembly 1 is situated within the interior of the housing 25 and fixed to a main shaft 2 by means of a mounting plate 3 for rotation therewith. The main shaft 2 extends through the rear plate 13 and bearing 26. As best seen in FIGS. 3 and 5, the rotor assembly 1 includes a generally disk-shaped plate with the outer periphery thereof serving as a foundation for a plurality of spaced rotor magnet assemblies 4. The magnet assemblies 4 are thus attached to the rotor assembly plate. The magnet assemblies 4 are arranged on the rotor assembly plate approximately one Magnetic Assembly (MA) diameter apart from each other. To provide an enhanced magnetic field, each of the magnet assemblies 4 includes at least two permanent magnets 5, as best seen in FIG. 4a, that are incased in a soft iron housing 6. Rotation of the main shaft 2 rotates the rotor assembly 1 such that the magnet assemblies 4 are rotated therewith. FIG. 4b illustrates the magnetic filed emanating from the magnet assemblies 4. FIGS. 4c and 4d are explained below.

As best seen in FIGS. 3 and 6, a stator assembly 7 having a generally disk-shaped plate is supported within the interior of the housing 25 by multiple Thompson Bearings 9 that extend inwardly from associated bearing shaft holders 10 mounted on the front plate 11 and are thus interconnected with the stator assembly 7. The stator assembly 7 is journaled on the shafts 9 so as to be movable with respect thereto away from the front plate 8 and toward the rear plate 13 and the rotor assembly 1. Linear actuators 12 through which the shafts 9 extend and which are connected to the plate of the stator assembly 7, provide such movement. Such movement preferably is driven under CPU control.

The stator assembly 7 includes a hub 14 on which a plurality of drive or stator magnet assemblies 15 are mounted. The drive magnet assemblies 15 are similar or somewhat similar in construction to the rotor magnet assemblies 4 in that they are inside a soft iron case 6, a pair or more of permanent magnets 16 that are spaced apart by fiber glass strips 17 and are arranged with their like planer surface poles facing one another such as depicted in FIGS. 4a-4d. In addition to such construction, the drive magnet assemblies 15 also include a flat electromagnetic coil 18 that generally covers the top of the magnet assembles (see FIG. 4d).

Preferably, each of the coils 18 is formed utilizing flat insulated magnet wire and are activated as a result of timing signals produced by the timing assembly 30 respectively to provide; an electromagnetic field in opposition to that of the permanent magnet assembles 15. The purpose of the coils 18 is to attenuate the magnetic field of the drive magnet assemblies 15 at selected times and to provide the electromotive force that pulls the rotor magnet assemblies 4 through a position dead center with respect to the drive magnet assemblies 15. Activation of the coils 18 occurs when the drive magnet assemblies 15 are approaching a position directly in line with the rotor magnet assemblies 4 so that the magnetic fields produced by the drive magnet assemblies 15 are disrupted and the fields of the coils 18 pull the rotor magnet assemblies pass the dead center position. Additionally or alternatively, a special metallic cover 24 can be affixed to the magnetic assembly of FIG. 4b to block and/or attenuate the magnetic flux on one side of the assembly.

The rotor magnet assembly 4 is comprised of one or more magnets oriented with its magnetic polarity vector perpendicular to the magnetic stacks. A multiplicity of magnets is typically used to enhance magnetic flux and/or to distort the magnetic field to increase overall performance. Magnets of virtually any size and shape can conceivably be used. However; a uniform rectangular box magnet is especially efficient. The magnets can be manufactured with one or more holes thru them in the direction of polarity to construct and maintain the magnet stack configuration with bolts/fasteners. It should also be noted that various adhesives can be used as well. The magnets are assembled together with north/south faces of attraction being employed to strengthen the magnetic field. Also in the stack, below the top set of magnets can be an intervening spacer of inert material 17. The magnets below the spacer face the other set with common polarity (I.e. north to north) this magnetic field interaction tends to distort the magnetic flux above the exposed stack face. The entire stack assembly is then encased in a high permeability box such as soft iron to attenuate, direct and contain the magnetic flux. The magnetic assemblies are then attached in a cylindrical manner to the stator disc perimeter. The rotor magnet assemblies are configured similarly with the reverse end of the stack left open to interact with the alternator winding 35 of the rotor assembly 1. The stator does not rotate in this configuration but is allowed to move longitudinally along the center axis of the shaft 2 thereby introducing it's set of magnetic assemblies into and adjacent to the magnet assemblies of the rotor.

The rotor can generally be a larger disc with its magnet assemblies positioned outside and closely adjacent to the stator 7 assembly magnet assemblies with like magnetic poles facing each other.

The rotor 1 is attached to the shaft 2 which is held in position via a set of bearings 26 which allow the shaft 2 to exit the housing 25 at both ends. Within the housing interior adjacent to the rotor is an alternator coil 35 attached in immediate proximity to the rotor perimeter and its magnet assemblies. The alternator winding is configured for the characteristic RPM and magnetic flux of the rotor. An alternator portion of the magnetic motor 100 described herein consists of a magnet wire winding toroid that encircles the rotor and is in close proximity to the magnet stack described herein. As the like polarity magnetic interaction between the rotor and stator produce rotations the winding to the exposed exterior side of the rotor magnet assemblies is excited by the electromagnetic force and a current is produced within the copper winding structure that can then be used for unit operation and modulated for electronic devices or connection to the electric grid.

The opposite mating half of the housing 25 is described as the stator housing and contains the linear actuators 12 attached to the stator 7 securing it to the housing and allowing for movement parallel to the shaft, providing rotor access to engage the stator magnet assemblies into position adjacent to and repelling the rotor magnet assemblies 4. The stator movement and proximity to the rotor magnet assemblies creates an adjustable repulsive force against and tangent to the rotor perimeter which will affect the speed of rotation of the rotor. The stator and rotor should never come into physical contact. The positioning of the magnet assemblies should be critically controlled allowing them to be in the closest possible proximity at their pole faces.

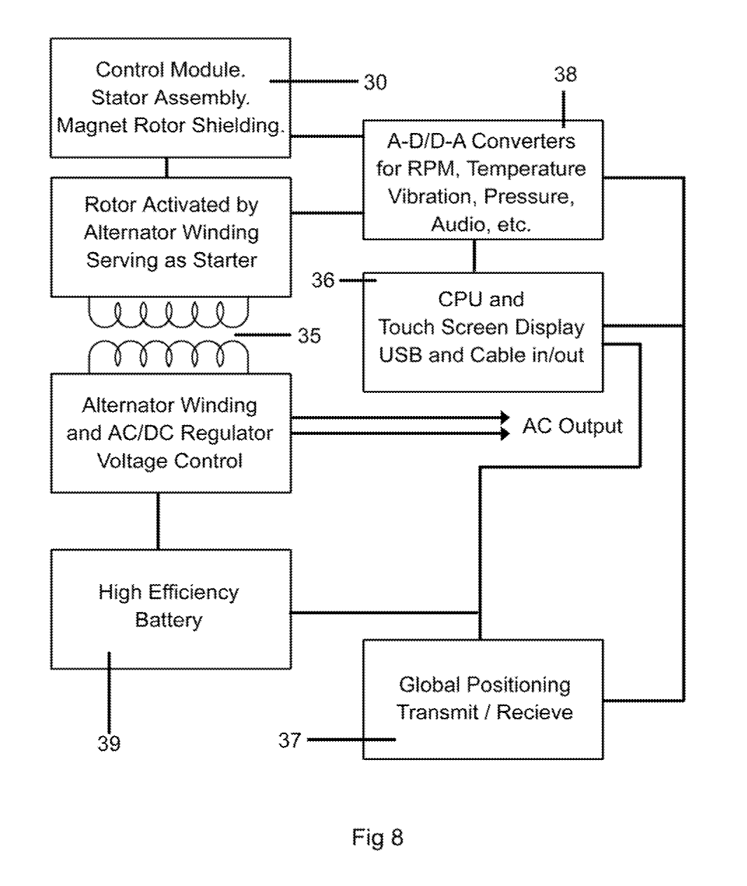

The internal housing 25 when hermetically sealed can be filled with a high permeability gas such as potassium bromide to enhance magnetic flux in the enclosed chamber. The housing needs to be made of metal and/or contain magnetic shielding components to attenuate the magnetic field. Numerous sensors are positioned strategically on the interior of the housing to measure temperature, vibration, acceleration, pressure, etc. of the unit 38. The data gathered is and transmitted to an embedded processor 36 and display for storage and transmission to the maintenance site. The processor also has GPS 37 capability that is uniquely identified to one unit (see FIG. 8).

Although the permanent magnets 5 are adapted to be less sensitive to high temperatures, to preserve their strength it is preferable to use an exterior cooling fan, attached to one end of the shaft 2, to provide heat dissipation in conjunction with internal and external fins 27.

A plurality of magnetic sensors 28 are incorporated into the stator assembly 7 and are connected to the control module 30 and timing assembly. The control module includes an electronic circuit and is shown in the block diagram of FIG. 8. The circuit is designed to receive the timing signals received from the magnetic sensors 28 and produce power pulses to activate the coils 18 of the drive magnet assemblies 15. When the sensors 28 detect the magnetic flux of the rotor magnet assemblies 4, a triggering signal is sent to a high power output circuit to complete a circuit path from the battery to the coils 18.

The rotor 1, in this case, is a balanced disk or ring that attaches to a rotational shaft. Motion is generated in the rotor through repulsion of a precisely designed and controlled permanent magnet excitation. There are many rotational and linear derivations of the design elements discussed herein forming a large number of possible configurations. The rotary approach tends to serve a more universal paradigm and has the added benefits of compact size per power output because of the dynamics associated with rotary motion. To maximize torque and therefore horsepower at the shaft of this device special design attention is given to weight distribution towards the perimeter of the rotor.

There are a variety of design criteria associated with the present magnetic motor that are not explained in the prior art. One of the primary design objectives to produce continuous rotary motion via magnetic repulsion is to minimize and/or eliminate the characteristic magnetic lockup that tends to occur under normal conditions within a magnetic environment like this. Magnetic lockup can be described as the condition where two or more magnets tend to reach equilibrium and consequently a static condition by equalizing the magnetic flux between all of the magnetic polar regions so as to reach the lowest kinetic energy state. This unwanted condition eliminates most of the kinetic energy and therefore motion.

Proper rotational performance cannot be achieved until the magnetic lockup condition is avoided or mitigated as much as possible by control of the magnetic flux and/or proper positioning of the magnets to produce the required flux vector required for motion. A design criterion that is disclosed and claimed herein with respect to the present invention is to avoid magnetic lockup is to space the magnets or magnet assemblies at a particular and required distance apart, whereas the flux from each individual magnet is negligible in comparison to the next magnet. Another criterion that is disclosed and claimed herein with respect to the present invention is to contain the magnetic field within a magnetic stack which is described and configured as multiple magnets that are sometimes positioned to maximize the extension of the magnetic flux towards one end of the magnetic stack, most often the open end.

The magnetic stack can be surrounded by an iron covering or shield to direct magnetic flux in a certain direction generally to the outside opening of an iron box, the iron box forming the or a portion of the magnetic motor housing. The iron or iron alloy box or shape surrounding the magnets is positioned very close to the surface of the magnetic material and would generally leave a polar side of the magnetic field uncovered thus providing an exit for an enhanced magnetic flux for that magnet assembly. Individual magnets are assembled in the stack in such a way that at least one set of like poles are positioned adjacent to one another which would tend to push the magnetic field on the opposite face of the magnet further from the face of the opposing pole. Such magnetic stacking is part of the design criteria of the present invention to maximize magnetic flux in the appropriate direction.

The greater magnetic flux the more power that can be created and therefore rotation created. In addition to increasing magnetic flux, higher energy magnets can also be used like rare earth, neodymium and carbon boron magnets, to produce higher magnetic fields thus creating more potential power.

Control and Operation

Sustained performance of the present magnetic motor 100 is dependent on maximizing the interaction of magnets and their flux vector. The vector polarity used is opposing poles like N to N or S to S. The magnetic flux lines shown in FIG. 4b are indicative of the rectangular magnets used in this design. The maximum repulsion is achieved when the left side of the stationary magnet is in immediate proximity to the right hand side of the rotor magnet. The speed of rotation is thereby controlled by switching the field on and off via the electromagnetic coils on the face of the stationary MA's. Another technique worth mentioning, is to control the magnetic flux by turning the magnet on and of mechanically by various means. One example of this is to use another set of magnets equal in power to the stationary MA's that are on the opposite side of the rotating disk. This set of MA's also rotate in sync with the shaft and tend to neutralize the stationary magnets until the magnetic flux boost is required. In this configuration it may be possible to minimize or eliminate the need for electromagnetic shielding.

Rectangular magnets are used here because of the large amount of magnetic force lines that can be maintained in opposition to one another. A wide range of other magnet shapes can be used to establish the desired magnetic flux characteristics. Great care must be taken to avoid interaction with unwanted polarity forces. These unwanted forces will tend to degrade performance and could inevitably allow for a magnetic lockup condition. To avoid this condition care must be taken to space the magnets far enough apart from each other to prevent unlike poles attracting.

Proper utilization of magnet containment is achieved in one configuration with a soft iron jacket around the magnetic stack and shielding of the flux lines via metallic shield interference and or switchable electromagnetic field generation through the associated circuit 30. Other configurations of the opposing magnet configuration are feasible and sometimes desirable. A similar rotating assembly can be created by positioning the MA's in opposition on flat cylindrical disks, for example. The configuration otherwise operates the same.

The performance of this device is further enhanced by the introduction of gas to fill the internal sealed chamber. Specifically, the chamber of the magnetic motor 100 is sealed with a gas of high Debye value like, but not limited to, potassium bromide which exhibit 10.41 Debye and can become highly polarized to enhance the repulsive or attractive effects between permanent and electro-magnets. Other high Debye value gases may be used.

The preceding illustrates some of the possibilities for practicing the invention. Many other embodiments are possible within the scope and spirit of the invention. For example, it is possible to utilize other variations for producing the power pulses provided by the timing assembly. The intention is that the foregoing description be regarded as illustrative rather than limiting, and that the scope of the invention is given by the appended claims together with their full range of equivalents.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. A magnetic motor comprising:
a plurality of rotor magnets positioned along a disk perimeter attached to a main shaft and defining a rotor;
a plurality of drive magnets positioned along a drive magnet stator and located generally inside the rotor magnets, the drive magnet stator being laterally movable into and out of the inside of the rotor for a distance between the rotor magnets and the drive magnets to increase and decrease magnetic drive force applied to the rotor magnets by the drive magnets and thereby control torque and speed of the shaft; and
a computer controlled timing assembly that receives power and generating power pulses which are selectively supplied to each rotor magnet.

2. The magnetic motor of claim 1, wherein the plurality of drive magnets each further comprises a magnet coil being longitudinally positioned on a surface of the drive magnets.

3. The magnetic motor of claim 1, wherein each of the drive magnets further comprises a pair of recharge plates mounted on opposite poles thereof.

4. The magnetic motor of claim 1, wherein each of the plurality of rotor magnets further comprises a pair of rotor magnet recharge plates mounted on opposite poles thereof.

5. The magnetic motor of claim 1, wherein the computer controlled timing assembly is driven by the main shaft via CPU control.

6. The magnetic motor of claim 1, further comprising:
a magnetic motor assembly forming a sealed housing with a chamber in which the drive magnets and the rotor magnets are located, the sealed housing filled with a numerically high Debye value gas;
an array of internal and external metal fins for heat exchange associated with the sealed housing; and
a rotating fan external to the sealed housing and driven by the rotor as the rotor extends through the sealed housing.

7. A magnetic motor comprising:
a plurality of front rotor magnets positioned along a front rotor attached to a main shaft;
a plurality of front drive magnets positioned along a front drive magnet hub and located generally adjacent the front rotor magnets;
a front drive magnet stator being movable with respect to the front rotor magnets for varying a distance between the front rotor magnets and the front drive magnets for increasing and decreasing drive force applied to the front rotor magnets by the front drive magnets, thereby controlling torque and speed of the main shaft;
a plurality of rear magnets positioned along a rear rotor attached to the main shaft;
a plurality of rear drive magnets positioned along a rear drive magnet stator and located generally adjacent to the rear rotor magnets, the rear drive magnet stator being movable corresponding to the movement of the front magnet stator with respect to the rear rotor magnets for varying a distance between the rear rotor magnets and the rear drive magnets for increasing and decreasing magnetic drive force applied to the rear rotor magnets by the rear drive magnets, thereby controlling torque and speed of the main shaft; and
a CPU controlled timing assembly that receives power and generating power pulses which are selectively supplied to the front and rear rotor magnets.

8. The magnetic motor of claim 7, wherein the plurality of front and rear drive magnets each have a magnet coil being longitudinally wound around the magnet.

9. The magnetic motor of claim 7, wherein each of the front and rear drive magnets active adjacent surfaces' magnetic field is attenuated to avoid a magnetic lock-up condition.

10. A magnetic motor comprising:
a plurality of rotor magnets positioned along a rotor fixed to a main shaft;
a plurality of drive magnets positioned along a drive magnet hub and located generally adjacent to the rotor magnet, the drive magnet hub being movable with respect to the rotor magnets for varying a distance between the rotor magnets and the drive magnets for increasing and decreasing magnetic drive force applied to the rotor magnets by the drive magnets, thereby controlling torque and speed of the main shaft; and
a cooling oil supply configured to supply oil to the motor magnets and the drive magnets thereby cooling the magnets during operation of the magnetic motor.

11. A magnetic motor comprising:
a plurality of rotor magnets positioned along a rotor fixed to a main shaft;
a plurality of drive magnets positioned along a drive magnet hub and located generally inside the rotor, the drive magnet hub being laterally movable into and out of the inside of the rotor for varying a distance between the rotor magnets and the drive magnets to increase and decrease magnetic drive force applied to the rotor magnets by the drive magnets to thereby control torque and speed of the main shaft; and
the drive magnet hub being laterally movable by a plunger.

12. The magnetic motor of claim 11, wherein the plunger is operated by one of a hydraulic or electro-mechanical control mechanism.

13. A magnetic motor comprising:
a plurality of rotor magnets positioned along a rotor attached to a main shaft;
a plurality of drive magnets positioned along a drive magnet hub and located generally inside the rotor, the drive magnet hub being laterally movable into and out of the inside of the rotor for varying distance between the rotor magnets and the drive magnets to increase and decrease magnetic drive force applied to the rotor magnets by the drive magnets and thereby control torque and speed of the shaft; and
a recharge device coupled with the drive magnets comprising a stationary commutator associated with the main shaft, and drive magnet recharge brushes in electrical contact with the commutator.

14. A magnetic motor comprising:
a plurality of front rotor magnets positioned along a front drive attached to a main shaft;
a plurality of front drive magnets positioned along a front drive magnet hub and located generally adjacent the front rotor magnets, the front drive magnet hub being movable with respect to the front rotor magnets for varying a distance between the front rotor magnets and the front drive magnets for increasing and decreasing drive force applied to the front rotor magnets by the front drive magnets thereby controlling torque and speed of the main shaft;
a plurality of rear rotor magnets positioned along a rear rotor attached to the main shaft;
a plurality of rear drive magnets positioned along a rear drive magnet hub and located generally adjacent to the rear rotor magnets, the rear drive magnet hub being movable corresponding to movement of the front magnet hub with respect to the rear rotor magnets for varying distance between the rear rotor magnets and the rear drive magnets for increasing and decreasing magnetic drive force applied to the rear rotor magnets by the rear drive magnets thereby controlling torque and speed of the main shaft; and
the rear magnet rotor in electro-magnetic interaction with an adjacent alternator coil assembly located within a magnetic motor housing that generates electrical current for a battery.

15. A magnetic motor comprising:
a plurality of front rotor magnets positioned along a front rotor attached to a main shaft;
a plurality of front drive magnets positioned along a front drive magnet hub and located generally adjacent the front rotor magnets, the front drive magnet hub being movable with respect to the front rotor magnets for varying distance between the front rotor magnets and the front drive magnets for increasing and decreasing the drive force applied to the front rotor magnets by the front drive magnets thereby controlling torque and speed of the main shaft;
a plurality of rear rotor magnets positioned along a rear rotor attached to the main shaft;
a plurality of rear drive magnets positioned along a rear drive magnet hub and located generally adjacent the rear rotor magnets, the rear drive magnet hub being movable corresponding to the movement of the front magnet hub with respect to the rear rotor magnets for varying distance between the rear rotor magnets and the rear drive magnets for increasing and decreasing magnetic drive force applied to the rear rotor magnets by the rear drive magnets thereby controlling torque and speed of the main shaft; and
the magnets being movable by one of a hydraulic or E&M CPU control mechanism.

16. A magnetic motor comprising:
a plurality of rotor magnets positioned along a rotor fixed to a main shaft;
a plurality of drive magnets positioned along a drive magnet hub and located generally adjacent the rotor magnets, the drive magnet hub being movable with respect to the rotor magnets for varying distance between the rotor magnets and the drive magnets for increasing and decreasing magnetic drive force applied to the rotor magnets by the drive magnets thereby controlling torque and speed of the main shaft; and
the drive magnets and associated electromagnetic field being switched on and off by a CPU controlled electromagnetic covering that is affixed atop the drive magnets.

17. A magnetic motor comprising:
a plurality of rotor magnets positioned along a rotor fixed to a main shaft;
a plurality of drive magnets positioned along a drive magnet hub and located generally adjacent the rotor magnets, the drive magnet hub being movable with respect to the rotor magnets for varying distance between the rotary magnets and the drive magnets for increasing and decreasing magnetic drive force applied to the rotor magnets by the drive magnets thereby controlling torque and speed of the main shaft; and
recharge means comprising, a rotor magnet recharge commutator associated with the shaft, rotor magnet recharge brushes which electrically contact the magnet recharge commutator, and conductive means extending from the recharge commutator to recharge plates associated with the rotor magnets.
